(19) United States
(12) Patent Application Publication
(10) Pub. No.: US 2021/0396465 A1
(43) Pub. Date: Dec. 23, 2021

(54) MIXED REFRIGERANT SYSTEM FOR NATURAL GAS PROCESSING

(71) Applicant: AZOTA GAS PROCESSING, LTD., Houston, TX (US)

(72) Inventor: Pierre E. Lugosch, Houston, TX (US)

(73) Assignee: AZOTA GAS PROCESSING, LTD., Houston, TX (US)

(21) Appl. No.: 17/289,594

(22) PCT Filed: Oct. 31, 2019
(86) PCT No.: PCT/US2019/059214

§ 371 Date: Apr. 28, 2021

Related U.S. Application Data
(60) Provisional application No. 62/753,392, filed on Oct. 31, 2018.

(51) Int. Cl. F25J 3/02

(52) U.S. Cl. CPC F25J 3/0209; F25J 3/0233; F25J 3/0238; F25J 3/0295; F25J 2200/02; F25J 2280/02; F25J 2200/94; F25J 2205/04; F25J 2270/18; F25J 2270/66; F25J 2270/902; F25J 2200/70

(57) ABSTRACT

A simplified mixed refrigerant system for natural gas processing which eliminates the need for storing, mixing and adjusting the individual hydrocarbon components of the refrigerant thereby rendering what are normally complex systems more practical for the natural gas liquid recovery industry.

### TECHNICAL FIELD

This disclosure relates to mixed refrigerant systems as they are applied during the processing of natural gas to recover valuable natural gas liquids.

### BACKGROUND

Conventional mixed hydrocarbon refrigerant systems are disfavored in the industry because of several complexities that must be dealt with when using mixed refrigerants. These may include: a) the refrigerant mixtures must be imported to the facility, b) the composition of the mixed refrigerant tends to change over time as the more volatile components leak from the system thereby changing the thermodynamic properties of the mixed refrigerant, c) the operating conditions of the plant, which may be market driven and/ or seasonal, may require the adjustment of the mixed refrigerant composition, and d) the individual pure components which make up the mixed refrigerant must be stored locally for mixture adjustment.

The present disclosure overcomes one or more the above difficulties and thereby enables the use of mixed hydrocarbon refrigerant systems with a significant cost advantage over the existing refrigeration systems.

### SUMMARY

This disclosure describes methods that effectively eliminate one or more of the previously described problems while yielding some or all of the benefits associated with mixed refrigerant systems. The present teachings achieve these benefits by taking advantage of the surprising discovery that mixed refrigerants can be generated conveniently in situ using largely the equipment which already exists for the associated natural gas liquids (NGL) or the liquid petroleum gas (LPG) recovery system. Methods according to the present disclosure can minimize or eliminate individual component storage at the plant site and the importation of a mixed refrigerant. The present methods may also facilitate automated control of the mixed refrigerant composition, and/or simplified operation for easy adoption by plant personnel.

In aspects, the present disclosure provides a mixed refrigeration system for low temperature natural gas processing that includes the step of using a refrigerant generated in situ without the need for importing, storing, metering or compositionally controlling the mixed refrigerant itself or the individual components thereof

In further aspects, the present disclosure provide a method for recovering natural gas liquids (NGL) from a natural gas stream. The method may include: receiving a natural gas stream into an inlet of a heat exchanger associated with a heat exchanger section; cooling the received natural gas stream using a mixed refrigerant circulated by a refrigerant loop to form a cooled and partially condensed natural gas stream; receiving the cooled and partially condensed natural gas stream in a separator to form an overhead gas stream and a liquid stream; stabilizing at least a portion of the liquid stream from the separator in a liquid stabilization system, wherein the liquid stream passes through a distillation column, the distillation column having a plurality of trays and a plurality of taps, each tap of the plurality of trays being in fluid communication with a tray of the plurality of trays; sending an overhead stream from the distillation column to the heat exchanger section; drawing a portion of the cooled NGL stream using at least one tap; and sending the portion of drawn cooled NGL stream to the refrigerant loop.

The above-recited example of features of the disclosure have been summarized rather broadly in order that the detailed description thereof that follows may be better understood, and in order that the contributions to the art may be appreciated. There are, of course, additional features of the disclosure that will be described hereinafter and which will form the subject of the claims appended hereto.

### BRIEF DESCRIPTION OF THE DRAWINGS

For detailed understanding of the present disclosure, references should be made to the following detailed description of the disclosure, taken in conjunction with the accompanying drawings, in which like elements have been given like numerals and wherein:

FIG. 1 is a schematic of a mixed refrigerant system for NGL recovery and processing according to one embodiment of the present disclosure;

FIG. 2 is a schematic of a mixed refrigerant system that uses a multi-stage cooling arrangement according to one embodiment of the present disclosure for NGL recovery from processing natural gas streams;

FIG. 3 is an illustrative method for using mixed refrigerant generated in situ according to one embodiment of the present disclosure for NGL recovery from processing natural gas streams; and

FIGS. 4 and 5A,B are tables illustrating the efficacy of using in situ generated mixed refrigerants for the systems illustrated in FIGS. 1 and 2, respectively.

### DETAILED DESCRIPTION

The present disclosure provides efficient methods and related systems for using mixed refrigerants during the processing of natural gas to recover natural gas liquids (NGL). The present disclosure is susceptible to embodiments of different forms. There are shown in the drawings, and herein will be described in detail, specific embodiments of the present disclosure with the understanding that the present disclosure is to be considered an exemplification of the principles of the present disclosure, and is not intended to limit the disclosure to that illustrated and described herein.

For clarity, certain aspects of the present teachings are described in the context of a generic NGL recovery and processing portion of a plant. In particular, the present teachings are described with reference to the refrigeration cycles or services of such a plant. As will be apparent from the discussion below, the advancements and advantages of the present teachings are in many aspects related to the charging, replenishment, and/or optimization of the mixed refrigerants used in these refrigeration systems.

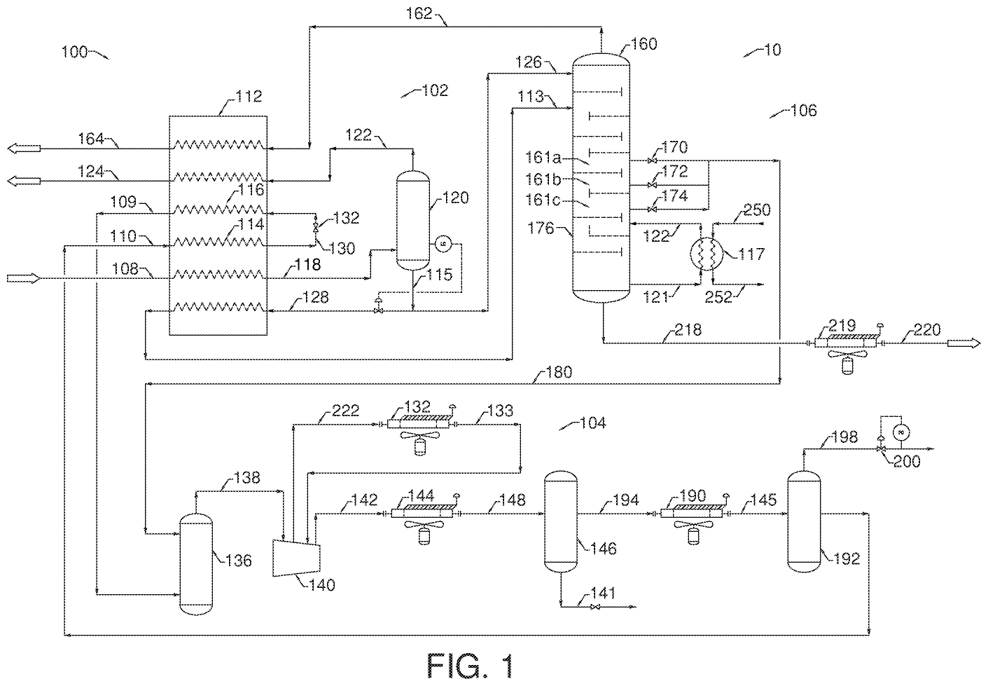

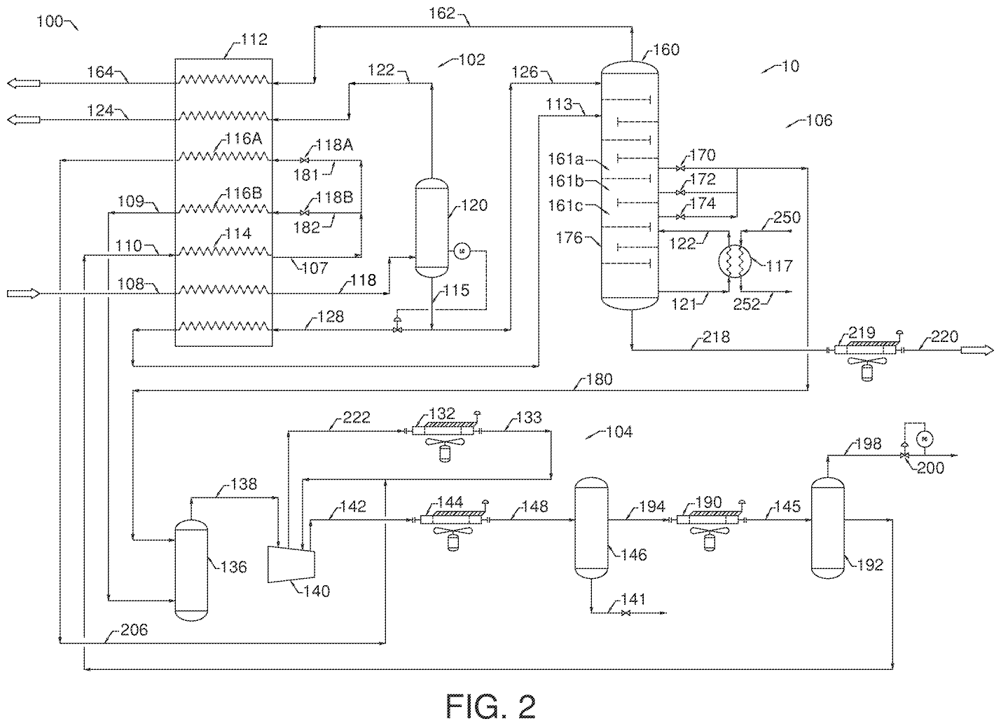

Conventional NGL recovery plants use a process known as a “Straight Refrigeration” process, which utilize a single component refrigerant, e.g., propane, in a two stage compression arrangement. These plants are typically limited to a refrigeration temperature of −40° F. to keep the system pressure outside of the vacuum range. Rather than using single component refrigerants for such conventional systems, the present disclosure utilizes mixed refrigerant systems as further discussed below. Two distinct non-limiting systems according to the present disclosure are discussed below with reference to FIGS. 1 and 2.

Referring to FIGS. 1 and 2, there is shown a NGL recovery plant 10 that includes a NGL recovery and processing system 100 that includes a heat exchanger section 102, a refrigerant loop 104, and a liquid stabilization section 106. An inlet gas, which is an NGL that contains gas, enters the plant 10 via a line 108 at a pressure such that a large percentage of the NGL can condense at below a temperature of 20° F. Typically, inlet gas enters a plant between 200 psig and 1200 psig. However, these are industry standards that have been established by long experience rather than absolute limits.

The heat exchanger section 102 includes one or more heat exchangers 112 that cool the inflowing plant inlet gas by using a mixed refrigerant circulated by the refrigerant loop 104. The inlet gas enters via the line 108 and the mixed refrigerant enters via line 110 from the refrigerant loop 104.

Referring to FIG. 1, the mixed refrigerant circulates in the heat exchanger 112 via a sub-cooler line 114 and an evaporation pass line 116. During operation, the inlet gas is cooled by the mixed refrigerant in the evaporation pass line 116 and exits the heat exchanger 112 via line 118 as a cooled and at least partially condensed stream.

Referring to FIGS. 1 and 2, the cooled two-phase stream in line 118 enters a separator 120. An overhead gas exits the separator 120 via a line 122 and passes again through the heat exchanger 112. The overhead gas in line 122 provides cooling duty in the heat exchanger 112 and exits via line 124 as a warmed product gas. A liquid stream exits the separator 120 as bottoms via line 115 and flows to the liquid stabilization section 106 directly via a line 126. Alternatively or additionally, the bottoms may flow indirectly via line 128 to the heat exchanger 112 and then via line 113 to the liquid stabilization section 160. The indirect flow of the liquid stream via the heat exchanger 112 may be desirable to obtain additional cooling duty from the liquid stream. While the heat exchanger 112 is shown as a single multi-pass exchanger, several heat exchangers may be used in other arrangements.

Referring to FIG. 1, during operation, a relatively warm mixed refrigerant liquid from the refrigerant loop 104 is fed via the line 110 to a warm inlet side of the heat exchanger 112 where it is cooled such that it is both completely condensed and sub-cooled in the sub-cooler line 114 before leaving the heat exchanger 112 via line 130. The cold mixed refrigerant stream in line 130 is dropped in pressure across a pressure reduction device 132 in order for the cold mixed refrigerant stream to serve as an cooling stream in the evaporation pass line 116. In accordance with the present teachings, a stream of mixed hydrocarbons at low pressure and temperature feeds the evaporation pass line 116 and boils until it is completely or nearly completely evaporated and thereafter exits the heat exchanger 112 as a warm vapor through line 109. The evaporation pass line 116 beneficially removes at a low temperature the heat of condensation of the inflowing inlet gas in line 108.

The refrigerant loop 104 receives the completely or nearly completely evaporated mixed refrigerant from line 109. The evaporated refrigerant stream in line 109, here a multi-component stream, is first directed to a scrubber 136 to remove any remaining liquid droplets and then as a vapor stream sent via a line 138 to a refrigerant compressor 140. It should be noted that the use of the scrubber 136 may not be needed because the use of a mixed refrigerant allows a complete evaporation of the fluid returning in line 109. Thus, the amount of liquid droplets may be sufficiently negligible to omit the scrubber 136. By “complete” evaporation or boiling, it is meant at least 99% by molar weight is composed of vapor.

Referring to FIGS. 1 and 2, the compressor 140 is configured to raise the pressure of the vapor stream in one or more stages to a pressure sufficient to permit partial or complete condensation at ambient conditions in the plant 10. In one embodiment, the compressor 140 may include multiple stages and incorporate a interstage cooler 132 that cools the mixed refrigerant passing between compression stages. The interstage cooler 132 may include a line 222 receiving the mixed refrigerant and a line 133 that returns the mixed refrigerant to the compressor 140. The pressurized vapor stream exiting the compressor 140 via line 142 may be partially condensed using a pre-condenser 144, which may use air-cooling or water cooling. It should be noted that the air or water will be at ambient conditions; i.e., at a temperature prevailing at or in the vicinity of the plant. The cooled pressurized condensed stream exiting the pre-condenser 144 may be sent to a separator 146 via line 148. Liquids may be drained from the separator 146 using a valved line 141. From the separator 146, the condensed mixed refrigerant may be circulated to a condenser 190 via line 194 and to an accumulator 192 via line 145 before being sent to the heat exchanger 112 via the line 110.

Referring still to FIGS. 1 and 2, the liquid stabilization section 106 is configured to remove light hydrocarbons, mostly methane and ethane, from the cooled NGL exiting the heat exchanger 112 so that the liquids can meet pipeline or other transportation specifications. The cold hydrocarbon liquids exiting the separator 120 via lines 126 and 128 are stabilized in a distillation column 160, which may either preferentially remove the methane or the methane and ethane. This distillation column 160 is commonly referred to as a Demethanizer or Deethanizer depending upon the desired component(s) to be removed. The overhead stream is conveyed via a line 162 from the distillation column 160 into the heat exchanger 112. The overhead stream exits the heat exchanger 112 as a warm gas stream in line 164 whence it may join the previously separated product gas in line 124. The distillation column 160 may include a reboiler 117 receiving a heating fluid via line 250 and distillation fluids from the distillation column 160 via line 121. The distillation fluids are returned to the distillation column 160 via line 122 and the heating fluid exits the reboiler 117 via line 252. A bottom stream exits the distillation column 160 via a line 218. The bottoms stream is condensed in a condenser 219 and exits as a products stream 220.

Referring still to FIGS. 1 and 2, in accordance with the teachings of the present disclosure, the distillation column 160 may be divided into a series of vertically stacked counter-current stages, each with a vapor and liquid stream in thermal and compositional equilibrium, these intermediate stages can used as a separate source of material streams with their own useful properties. In contrast to conventional interest that is limited to only the composition of the product streams leaving the top and bottom of the distillation column 160, the present disclosure utilizes the intermediate streams, which have properties that the inventor has perceived as being beneficial. The equilibrium stages 161a,b,c, or “theoretical trays,” including and above the bottom stage where the reboiler 117 is located, are of a composition the inventor has found to be suitable for the mixed refrigerant stream used in the refrigeration loop 104. Of most interest is the gaseous phases on the trays 161a-c closer to the bottom 176 of the distillation column 160. The inventor has observed that the composition of these gaseous internal streams have significant quantities of ethane, propane, butane, pentane and heavier hydrocarbons which permit them to be condensed at pressures and evaporated at pressures similar to those seen in conventional pure component systems but at much lower temperatures. These steams, the inventor has recognized, are nearly ideal as “mixed refrigerant” compositions.

In one non-limiting embodiment of the present disclosure, one or more taps 170, 172, 174, are used to draw vapor at one or more trays at or near a bottom 176 of the distillation column 160. Where multiple taps are used, the taps are vertically stacked to draw compositionally different vapors, which are at thermal and compositional equilibrium at their respective trays. The refrigeration loop 104 can be charged or replenished with mixed refrigerant using a side draw from one or more of the taps 170, 172, 174 of the distillation column 160.

In one arrangement, a vapor draw in line 180, which may be from one or more of the taps 170, 172, or 174, is obtained by opening suitable valves or other flow control devices when the refrigeration loop 104 requires a charge of mixed refrigerant. In most instances, the charging process is intermittent as opposed to continuous, but the time and duration of the charging is situation specific. The vapor draw is routed via line 180 to the refrigeration compressor 140 either directly or via the scrubber 136 or to any other point in the refrigeration loop 104 that is convenient. The drawn vapor in line 180 is generally at the pressure and temperature of the fluids in the distillation column 160.

Thus, it should be appreciated that the teachings of the present disclosure provide a system wherein a mixed refrigerant is generated in situ without the need for importing, storing, metering or compositionally controlling the mixed refrigerant itself or the individual components thereof. As illustrated in the FIGS. 1 and 2 systems, all of the mixed refrigeration in the refrigeration loop 104 is in situ generated mixed-refrigerant. In other arrangements, the in situ generated mixed-refrigerant may be used to supplement a pre-existing refrigerant or used in conjunction with externally generated mixed-refrigerants.

In arrangements, the refrigeration loop 104 may be filled and started with little attention to the composition of the vapor draw. Thereafter, the fractions of components in the mixed refrigerant circulating in the refrigerant loop 104 may be adjusted as desired by adding or removing fluids from the refrigerant loop 104. In some arrangements, the adjustment may be performed without regard to any particular criteria. In other arrangements, the adjustment may be performed with reference to historical data, system tendencies, and/or one or more observed system dysfunctions.

Referring to FIGS. 1 and 2, generally, an adjustment to the fractional composition of the mixed refrigerant in the refrigerant loop 104 may be made by draining a liquid from the refrigerant loop 104, venting a gas from the refrigerant loop 104, and/or adding one or more vapor streams from the taps 170, 172, 174 via line 180 to the refrigerant loop 104.

Referring still to FIGS. 1 and 2, in one mode of operation, plant personnel may use historical data or system tendencies in order to make an adjustment. For example, the system 100 may have a tendency to generate too much of a more volatile component during start-up. Therefore, plant personnel may vent gas from and/or add less volatile components to the refrigeration loop 104 as a matter of course after start-up. In another example, the system 100 may have a tendency to generate too much of a less volatile component after a certain number of hours of operation. Therefore, plant personnel may drain liquid from and/or add more volatile components to the refrigeration loop 104 as a matter of course during prolonged operation.

In another mode of operation, plant personnel may, in addition or as an alternative to using historical data or system tendencies, monitor the system 100 for one or more system dysfunctions as a basis for making one or more adjustments. As used herein, a “system dysfunction” is a detectable behavior or condition, generally a “parameter,” that is outside an established or desired value or range. System parameter include, but are not limited to, pressure, temperature, fluid flow rate, mixture compositions (e.g., presence or absence of pure components and percentage amounts), power consumption (e.g., current flow, horsepower, etc.), and fractional phase compositions (e.g., amount of gas or liquid). One or more of these parameters may be directly or indirectly measured or otherwise quantified using suitable instruments. Generally, the term “estimating a parameter” encompasses both direct measuring and inferential measuring.

As mentioned above, an undesirable amount of less volatile components may be remedied by removing the less volatile component from or adding a more volatile component to the refrigeration loop 104.

One illustrative parameter that may be estimated in order to determine whether such an adjustment is desirable is the temperature of the mixed refrigerant stream entering the heat exchanger section 102. For example, an excessive amount of less volatile components accumulating in the refrigerant loop 104 can be manifested by an undesirably high temperature in the mixed refrigerant stream in line 110 entering the heat exchanger 112. What is “undesirably high” for a temperature will, of course, depend on the configuration of a particular system. Generally speaking, a temperature will be undesirably high if cooling of the natural gas is to an insufficiently low temperature. This high temperature condition may be alleviated by using the pre-condenser 144 between the discharge of the refrigerant compressor 140 and the main refrigerant condenser 146. The partially cooled mixed refrigerant exiting the pre-condenser 144 via line 148 will have condensed heavier hydrocarbon components. These heavier hydrocarbon components may be separated in the separator 146 thereby leaving a mixed refrigerant in line 194 with a lower boiling point. The mixed refrigerant stream in line 194 then flows for further condensation through the mixed refrigerant condenser 190. The pre-condenser 144, may also be conveniently located at the refrigerant compressor interstage cooler 132 or vapor draw line 180.

Additionally or alternatively, an undesirably high fractional amount of less volatile components in the refrigeration loop 104 may be addressed by adding more volatile components to the refrigeration loop 104. Increasing the concentration of the more volatile components in the mixed refrigerant stream may be achieved by drawing system makeup vapors from a higher tray in the distillation column 160, e.g., tray 170 or tray 172.

As also mentioned above, an undesirable amount of more volatile components may be remedied by removing the more volatile component from or adding a less volatile component to the refrigeration loop 104.

One illustrative parameter that may be estimated in order to determine whether such an adjustment is desirable is the pressure of the mixed refrigerant stream at one or more locations in the refrigeration loop 104. For example, an excessive accumulation of more volatile components, typically methane or ethane, in the refrigeration loop 104 can be indicated by a rise in the discharge pressure of mixed refrigerant exiting the refrigerant compressor 140. To alleviate the higher pressure condition, the discharge of the mixed refrigerant condenser 190 may directed to the mixed refrigerant accumulator 192, which may be connected to a vent line 198. Flow across the line 198 is controlled by a control valve 200. When the discharge pressure exceeds a predetermined maximum, the control valve 200 opens flow across the line 198 to vent the volatile gas stream from the accumulator 192 via the vent line 198. The volatile gas stream may also be sent to any desired location, e.g., distillation column overhead or to a sales gas stream. Such an arrangement can selectively remove the excessive light ends until the condensing pressure drops to a desired set point. In such arrangements, an optimum mix is determined primarily by the condensing pressure of the mixture in the pre-condenser 144.

Additionally or alternatively, an undesirably high fractional amount of more volatile components in the refrigeration loop 104 may be addressed by adding less volatile components to the refrigeration loop 104. Increasing the concentration of the less volatile components in the mixed refrigerant stream may be achieved by drawing system makeup vapors from a lower tray in the distillation column 160, e.g., tray 172 or tray 174.

It should be understood that monitoring pressure and temperature as described above are merely illustrative of the parameters that may be estimated to determine whether adjustments are desirable. Other parameters that may be estimated include the power consumption of the compressor 140 and the overhead and bottoms compositions for the separator 120.

Similar processes are used which also include the turbo-expansion of the inlet gas for provision of a portion of the required refrigeration. It should be noted that there are many hundreds of variants of the above processes. The present disclosure is directed to those which may use a mixed refrigeration system and a liquid stabilization system as described above.

Referring to FIG. 2, there is shown another embodiment of an NGL processing system in accordance with the present disclosure. Like the FIG. 1 embodiment, the NGL plant 10 that includes a NGL processing system 100 that includes a heat exchanger section 102, a refrigerant loop 104, and a liquid stabilization section 106. The NGL containing gas enters the plant 10 via the line 108. The refrigerant loop 104 and the liquid stabilization section 106 are similar to those already described in connection with FIG. 1. Moreover, the modes of operation as similar to that previously described.

In the FIG. 2 system, the heat exchanger section 102 has been modified to use a multi-stage cooling arrangement. The heat exchanger section 102 includes one or more heat exchangers 112 that cool the inflowing NGL gas by using a mixed refrigerant circulated by the refrigerant loop 104. LPG gas enters via the line 108 and the mixed refrigerant from the refrigerant loop 104 enters via line 110. The mixed refrigerant flows across in the heat exchanger 112 via a sub-cooler line 114 and exits via line 107. The line 107 splits the flow into line 181 and line 182. Line 181 feeds an evaporation pass line 116a and line 182 feeds evaporation pass line 116b. Pass lines 116a,b each have suitable flow control devices 118a,b such as valves. The mixed refrigerant in the lines 116a,b boil until completely or nearly completely evaporated and thereafter exits the heat exchanger 112 via separate lines 109, 206. The mixed refrigerant in line 206 is sent to the line 133 connected to the outlet of the interstage cooler 132. The cooled mixed refrigerant exiting the interstage cooler 132 commingles with the mixed refrigerant from line 206 and enters the compressor 140. The mixed refrigerant in line 109 is sent to the scrubber 136 or directly to the compressor 140.

In one mode of operation, the mixed refrigerant stream in line 181 is flashed across valve 118a to form a mixed refrigerant stream having a pressure matched to an interstage pressure of the mixed refrigerant compressor 140. The mixed refrigerant stream in line 182 is flashed across the valve 118b to have a pressure matched to the low-pressure inlet pressure of the compressor 140. By “matched,” a pressure above the pressure of the interstage compressor or the inlet pressure of the compressor 140. In embodiments, approximately 40% of the mixed refrigerant in line 107 is directed into the pass line 116a, which is at higher interstage pressure. This division of the mixed refrigerant stream is possible since all of the refrigeration need not be provided at the low temperature corresponding to the inlet of the compressor 140.

The low pressure mixed refrigerant stream in line 116b is warmed in cross exchange with the warm inlet gas stream in line 108 to a temperature close to the inlet gas temperature, or superheated as it is in the simpler one stage mixed refrigerant design. The mixed refrigerant stream in line 116b is then directed to the low-pressure inlet of the refrigerant compressor 140. Similarly, the higher pressure mixed refrigerant stream in line 116a is warmed in cross exchange with the inlet gas in line 108 to a temperature that is above ambient temperature or superheated. The mixed refrigerant stream in line 206 is then directed to the line 133 connected to the interstage cooler 132 as described above.

As discussed above, in the FIGS. 1 and 2 systems, the mixed refrigerant compressor 140 includes an interstage cooling loop 220 that the cooler 132, the inlet stream 222, and the outlet stream 133. It should be understood that such a feature is merely optional for mixed refrigerant systems according to the present disclosure. The interstage cooling 132 may or may not be located at the same stage that the partially or completely boiled mixed refrigerant in line 206 returns to the mixed refrigerant compressor 140. That is, the line 206 may be connected to a different compressor interstage (not shown). Without being bound by any particular theory, it is believed that by reducing mixed refrigerant flow to the inlet of the compressor 140 and delivering a portion of the mixed refrigerant flow to the outlet of the interstage cooler 132 or other interstage, a reduction in compression horsepower similar to that seen in conventional single component systems may be realized.

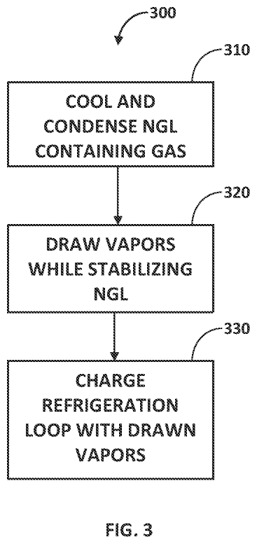

FIG. 3 illustrates a flow chart depicting a method according to one embodiment of the present disclosure. The method includes: the step 310 of cooling and at least partially condensing a NGL that contains gas in a heat exchanger section that receives a mixed refrigerant from a mixed refrigerant loop; the step 320 of drawing vapors from one or more taps from theoretical trays in distillation column in which the cooled NGL is being stabilized; and the step 330 of using the withdrawn vapor stream as a mixed refrigerant to charge the mixed refrigerant loop.

A mixed refrigerant is an engineered fluid composed of two or more fluids, the compositions and relative amounts of which are intentional and controlled. For the purposes of the present disclosure, a mixed refrigerant is composed of two or more pure components each of which is present in significant amounts and thereby each having a contributory effect on the boiling point, enthalpy and condensing temperature of the mixed refrigerant. By “significant,” it is meant at least 5% in molar weight. In the hydrocarbon processing industry the pure components may be any of the paraffinic hydrocarbons, as well as nitrogen. Mixed refrigerants boil over a broad range of temperatures unlike pure component refrigerants which boil at a constant temperature thereby providing more efficient refrigeration cycles. Usually, mixed refrigerants are not fully condensable at ambient temperatures as are pure component refrigerants, but must be at least partially condensed in cross exchange with the cold returning refrigerant exiting the cooling portion of a process. Generally, mixed refrigerants according to the present disclosure include nitrogen, methane, ethane, propane, n-butane, isobutene, isopentane, n-pentane and n-hexane. It should be understood that fluids having primarily a single component and trace amounts or unintentional amounts of secondary substances are not an engineered fluid or a mixed refrigerant according to the present disclosure.

### EXAMPLES

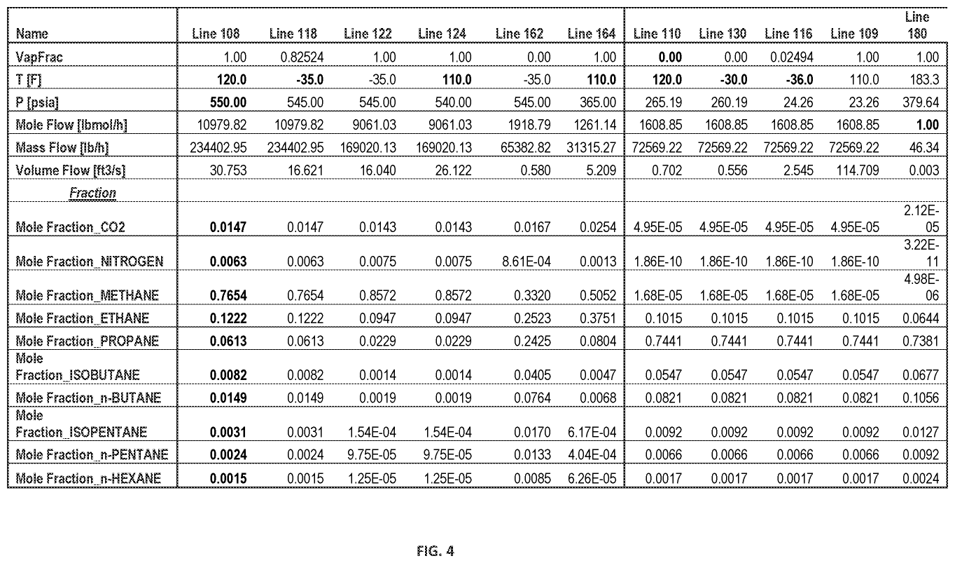

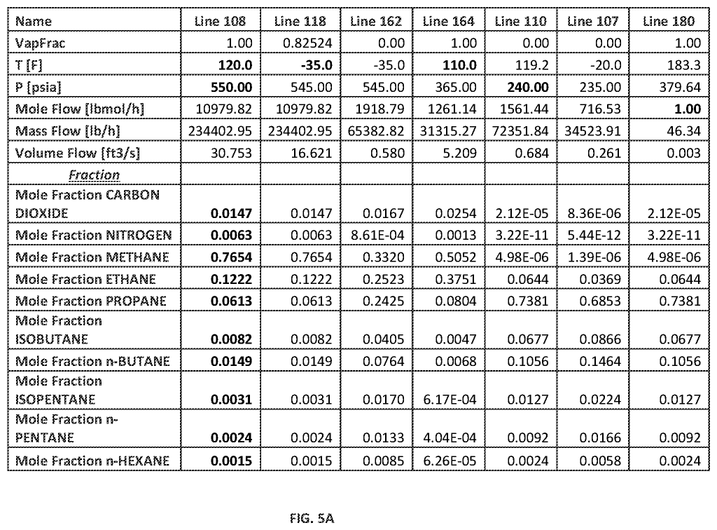

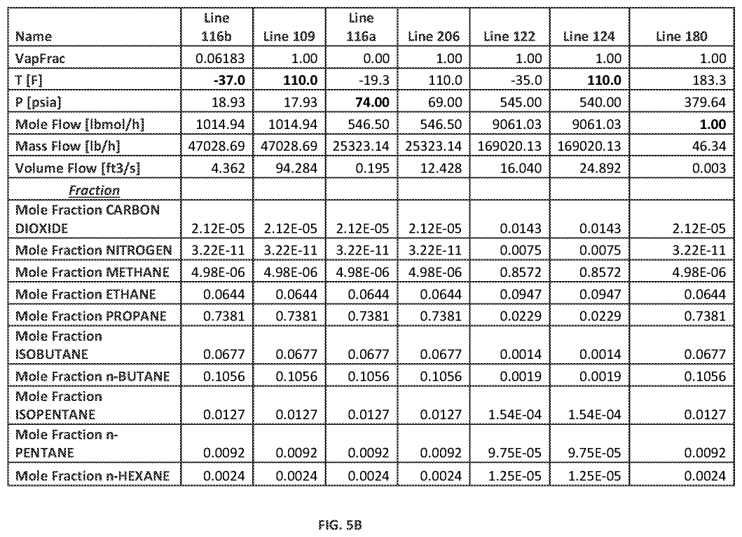

Referring to FIGS. 4 and 5A,B, there are shown tables furnishing selected operating parameters for simulations performed for the systems represented by FIGS. 1 and 2, respectively. For each table, the columns represent individual system lines and the rows represent a computer simulated value for a given value. The system lines of FIG. 4 correspond to the numerals used in FIG. 1 to identify lines. The system lines of FIGS. 5A,B correspond to the numerals used in FIG. 2 to identify lines. For each line, the table provides the vapor fraction (VapFrac), the temperature (T), the pressure (P), molecular flow rate, and mass flow rate. Also shown are the fraction of pure components at each line. The pure components include nitrogen, methane, ethane, propane, n-butane, isobutene, isopentane, n-pentane and n-hexane.

Each table includes the names of the pure components and their fractional values in line 180, which conveys the vapor draws from taps 170, 172, and/or 174 to the refrigeration loop 104. It should be noted that all of these pure components are also present in line 110, which supplies mixed refrigerant to the heat exchanger 112. Moreover, the relative fractional values of the pure components in line 180 generally correspond to the relative fractional values for the pure components in line 110. For example, propane has the largest relative fractional values in each of lines 180 and 110. Thus, the simulations indicate vapors taken from taps 170, 172, 174 formed in the distillation tower 160 can provide pure components for supplying a mixed refrigerant to the refrigeration loop 104. The effectiveness of the operation of the refrigeration loop 104 can be observed by the change in temperature of the fluids passing through the heat exchanger 112. That is, it is readily apparent that relatively warm fluids entering the heat exchanger 112 are cooled, and the relatively cool fluids entering the heat exchanger 112 are warmed.

From the above, it should be appreciated that what has been described includes a method for recovering natural gas liquids (NGL) from a natural gas stream. The method may include: receiving an natural gas stream into an inlet of a heat exchanger associated with a heat exchanger section; cooling the received natural gas stream using a mixed refrigerant circulated by a refrigerant loop to form a cooled and partially condensed natural gas stream; receiving the cooled and partially condensed natural gas stream in a separator to form an overhead gas stream and a liquid stream; stabilizing at least a portion of the liquid stream from the separator in a liquid stabilization system, wherein the liquid stream passes through a distillation column, the distillation column having a plurality of trays and a plurality of taps, each tap of the plurality of trays being in fluid communication with a tray of the plurality of trays; sending an overhead stream from the distillation column to the heat exchanger section; drawing a portion of the cooled NGL stream using at least one tap; and sending the portion of drawn cooled NGL stream to the refrigerant loop.

From the above, it should be appreciated that what has been described includes a method for recovering natural gas liquids (NGL) from a natural gas stream. The method may include: receiving an natural gas stream into an inlet of a heat exchanger associated with a heat exchanger section; cooling the received natural gas stream using a mixed refrigerant circulated by a refrigerant loop to form a cooled and partially condensed natural gas stream; receiving the cooled and partially condensed natural gas stream in a separator to form an overhead gas stream and a liquid stream; stabilizing at least a portion of the liquid stream from the separator in a liquid stabilization system, wherein the liquid stream passes through a distillation column, the distillation column having a plurality of trays and a plurality of taps, each tap of the plurality of trays being in fluid communication with a tray of the plurality of trays; sending an overhead stream from the distillation column to the heat exchanger section; drawing a portion of the cooled NGL stream using at least one tap; and sending the portion of drawn cooled NGL stream to the refrigerant loop.

In embodiments where the mixed refrigerant circulates in the heat exchanger via a sub-cooler line and an evaporation pass line, the method may further include the steps of: dropping a pressure of the mixed refrigerant using a pressure reduction device connected between the sub-cooler line and the evaporation pass line; completely vaporizing the mixed refrigerant in the evaporation pass line; receiving and compressing the completely vaporized mixed refrigerant in a compressor associated with the refrigerant loop; cooling the compressed mixed refrigerant using at least one cooler; and sending the cooled compressed mixed refrigerant to the heat exchanger section, the cooled compressed mixed refrigerant being the mixed refrigerant used to cool the natural gas stream.

In embodiments, the method may further include the steps of estimating a parameter relating to a dysfunction at at least one of: (i) the heat exchanger section, (ii) the refrigerant loop, and (iii) the liquid stabilization section; and adjusting a fractional amount of at least one component in the mixed refrigerant circulating in the refrigerant loop in response to the estimated parameter. In embodiments, the estimated parameter is a temperature at the heat exchanger and the fractional amount is adjusted if the estimated temperature is above a predetermined value.

In embodiments, the estimated parameter is a temperature at the heat exchanger and the fractional amount is adjusted if the estimated temperature is above a predetermined value. In embodiments, the fractional amount is adjusted by at least one of: (i) draining at least a portion of a liquid volatile component from the mixed refrigerant; and (ii) adding a vapor from the distillation column to the mixed refrigerant.

In embodiments, the estimated parameter is a pressure at location in the refrigeration loop; and wherein the fractional amount is adjusted if the estimated pressure is above a predetermined value. In embodiments, the fractional amount is adjusted by at least one of: (i) venting at least a portion of a gaseous volatile component from the mixed refrigerant; and (ii) adding a vapor from the distillation column to the mixed refrigerant.

In embodiments, the method may further include the steps of condensing the mixed refrigerant circulating in the refrigerant loop using a media at an ambient temperature, the media being at least one of: air and water. In many instances, the ambient temperature is the approximately the same as the air temperature in the immediate vicinity of the media.

In embodiments, the method may further include the steps of distributing each tap of the plurality of taps to draw a vapor having a substantially different component from a vapor drawn by an adjacent tap. Generally, two components are “substantially different” if they share less than about five percent of substances having the same chemical make-up.

In further variants, what has been described include the further steps of condensing a mixed refrigerant using a media at an ambient temperature, the media being at least one of: air and water.

The foregoing description is directed to particular embodiments of the present disclosure for the purpose of illustration and explanation. It will be apparent, however, to one skilled in the art that many modifications and changes to the embodiment set forth above are possible without departing from the scope of the disclosure. For example, while trays are referred to in the above discussion, certain distillation towers may use packed beds. Thus, it is intended that the following claims be interpreted to embrace all such modifications and changes.

What is claimed is:

1. A method for recovering natural gas liquids (NGL) from a natural gas stream, comprising:
receiving a natural gas stream into an inlet of a heat exchanger associated with a heat exchanger section;
cooling the received natural gas stream using a mixed refrigerant circulated by a refrigerant loop to form a cooled and partially condensed natural gas stream;
receiving the cooled and partially condensed natural gas stream in a separator to form an overhead gas stream and a liquid stream;
stabilizing at least a portion of the liquid stream from the separator in a liquid stabilization system, wherein the liquid stream passes through a distillation column, the distillation column having a plurality of trays and a plurality of taps, each tap of the plurality of trays being in fluid communication with a tray of the plurality of trays;
sending an overhead stream from the distillation column to the heat exchanger section;
drawing a portion of the cooled NGL stream using at least one tap; and
sending the portion of drawn cooled NGL stream to the refrigerant loop.

2. The method of claim 1, wherein the mixed refrigerant circulates in the heat exchanger via a sub-cooler line and an evaporation pass line, and further comprising:
dropping a pressure of the mixed refrigerant using a pressure reduction device connected between the sub-cooler line and the evaporation pass line;
completely vaporizing the mixed refrigerant in the evaporation pass line;
receiving and compressing the completely vaporized mixed refrigerant in a compressor associated with the refrigerant loop;
cooling the compressed mixed refrigerant using at least one cooler; and
sending the cooled compressed mixed refrigerant to the heat exchanger section, the cooled compressed mixed refrigerant being the mixed refrigerant used to cool the natural gas stream.

3. The method of claim 1, further comprising:
estimating a parameter relating to a dysfunction at at least one of: (i) the heat exchanger section, (ii) the refrigerant loop, and (iii) the liquid stabilization section; and
adjusting a fractional amount of at least one component in the mixed refrigerant circulating in the refrigerant loop in response to the estimated parameter.

4. The method of claim 3, wherein the estimated parameter is a temperature at the heat exchanger; and wherein the fractional amount is adjusted if the estimated temperature is above a predetermined value.

5. The method of claim 4, wherein the fractional amount is adjusted by at least one of: (i) draining at least a portion of a liquid volatile component from the mixed refrigerant; and (ii) adding a vapor from the distillation column to the mixed refrigerant.

6. The method of claim 3, wherein the estimated parameter is a pressure at location in the refrigeration loop; and wherein the fractional amount is adjusted if the estimated pressure is above a predetermined value.

7. The method of claim 6, wherein the fractional amount is adjusted by at least one of: (i) venting at least a portion of a gaseous volatile component from the mixed refrigerant; and (ii) adding a vapor from the distillation column to the mixed refrigerant.

8. The method of claim 1, further comprising condensing the mixed refrigerant circulating in the refrigerant loop using a media at an ambient temperature, the media being at least one of: air and water.

9. The method of claim 1, further comprising:
distributing each tap of the plurality of taps to draw a vapor having a substantially different component from a vapor drawn by an adjacent tap.

10. A mixed refrigeration system for low temperature natural gas processing, comprising:
using a mixed refrigerant generated in situ without the need for importing, storing, metering or compositionally controlling the mixed refrigerant itself or the individual components thereof

11. The method of claim 10, further comprising condensing a mixed refrigerant using a media at an ambient temperature, the media being at least one of: air and water.

12. The method of claim 10, further comprising further condensing and subcooling the mixed refrigerant.

13. The method of claim 12, further comprising: expanding and evaporating the subcooled mixed refrigerant as a source of refrigeration for a natural gas processing plant.

14. The method of claim 13, wherein the mixed refrigerant is generated using vapor drawn from at least one tray installed in a distillation column of the natural gas processing plant.
